(19) United States
(12) Patent Application Publication
(10) Pub. No.: US 2010/0313768 A1
(43) Pub. Date: Dec. 16, 2010

(54) SYSTEM FOR FACILITATING FOOD PREPARATION

(75) Inventors: George F. Koether, Southport, CT (US); Edward J. Musial, Milford, CT (US); Ben Rosenfeld, Milford, CT (US); William Flynn, Naugatuck, CT (US)

Correspondence Address: EDWARDS ANGELL PALMER & DODGE LLP, P.O. BOX 55874, BOSTON, MA, 02205, US

(73) Assignee: Technology Licensing Corporation, Fort Lauderdale, FL (US)

(21) Appl. No.: 12/563,650

(22) Filed: Sep. 21, 2009

Related U.S. Application Data
(60) Provisional application No. 61/187,076, filed on Jun. 15, 2009.

(51) Int. Cl. A47J 36/00

(52) U.S. Cl. 99/325

(57) ABSTRACT

A system for facilitating the preparation of food comprising a database, a database storing recipe information regarding the process for preparing a particular food item in accordance with the recipe, and the database storing a visual cue corresponding to the performance of a server communicating with the database.

### CROSS-REFERENCE TO RELATED APPLICATIONS

This Application claims priority to U.S. Provisional Application No. 61/187,076 filed on Jun. 15, 2009 in its entirety.

### BACKGROUND OF THE INVENTION

This invention is directed to a system for facilitating food preparation, and in particular, for providing real time audio visual prompts for the proper preparation and operation of a kitchen appliance.

In commercial restaurants, particularly the quick serve restaurants, the kitchen staff has little education, little training, and often does not speak the English language. However, even in quick serve restaurants, anyone operating a kitchen appliance is required to remember a number of different recipes and operate equipment which is deceptively sophisticated. In this day and age, even a fryer makes use of onboard computers and a number of controls to cook a number of different items such as french fries, chicken wings, shrimp, chicken tenders and more depending on the style of the restaurant. The same is even more true of a more universal cooking device such as an oven in which the same device may be responsible for cooking a pizza, baking bread or making cookies, sometimes at the same time. The issue also is involved where there is no intelligent cooking equipment such as a wok, fry pan or grill, in which there is no sophisticated computer control for automating the various different cooking operations.

As a result, as is human nature, inappropriate operation of the equipment occurs. At best, this results in an inconsistent food product, which may damage the customer's experience. At worst, it may result in insufficient cooking in violation of food safety codes, which could result in a health hazard. Accordingly, a system for overcoming the shortcomings of the prior art is desired.

### BRIEF DESCRIPTION OF THE DRAWINGS

Other objects, features, and advantages of the present invention will be apparent from the written description and the drawings in which:

FIG. 1 is a schematic drawing of a system constructed in accordance with the invention;

FIG. 2 is a representative recipe and process file created and stored in the database in accordance with the invention;

FIG. 3 is an exemplary screen shot created by the system at a monitor for beginning the process in accordance with the invention;

FIG. 4 is a representative screen shot for a product build as presented in accordance with the invention;

FIG. 5 is a flow chart for operating the system for the product build process in accordance with the invention;

FIG. 6 is a flow chart for operating the system for the process for prompting food preparation in accordance with the invention;

FIG. 7 is a flow chart for operating the system in accordance with spacing rules for the process for prompting food preparation in accordance with the invention;

FIG. 8 is an exemplary screen shot created by the system in accordance with the invention;

FIG. 9 is an exemplary screen shot created by the system in accordance with the invention; and

FIG. 10 is an exemplary screen shot created by the system in accordance with the invention.

### DETAILED DESCRIPTION OF THE PREFERRED EMBODIMENTS

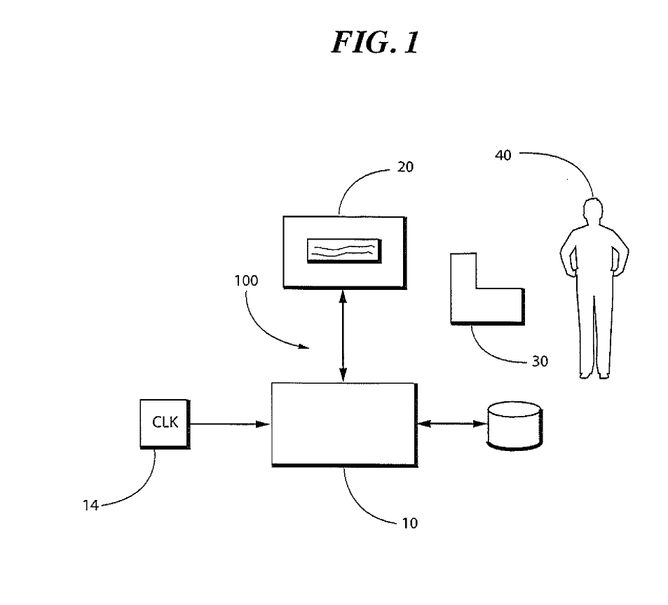

Reference is first made to FIG. 1 wherein a system for facilitating food preparation, generally indicated as 100 is provided. System 100 is utilized to teach operators of kitchen appliances how to prepare food, as well as to provide real time prompts during the food preparation process. System 100 includes a server 10 having an associated database 12. As will be described below, database 12 stores at least the process steps, recipes, and cooking rules for various food products to be prepared at the kitchen appliance 30 of interest. A clock 14 is either associated with or formed as part of server 10. Server 10 communicates with an audio visual display 20 which is in two-way communication with server 10 for displaying audio visual instructions to an operator of the kitchen appliance 30 and/or receiving inputs from operator 40.

At least audio visual display 20 is in the kitchen environment and either adjacent with or formed as part of a kitchen appliance 30. In this way, display 20 is always readily accessible to an operator 40. It should be noted that kitchen appliance 30 is not necessarily a part of the invention or system 100. As will be described in detail below, the server 10 transmits audio visual cues regarding the preparation of particular food products to audio visual display 20. In one embodiment, the visual cues are changed at timed intervals in accordance with the process of a recipe being performed by an operator 40.

When preparing food, a recipe is associated with a process. Certain steps and ingredients occur in a chronological manner. For example, when preparing a pasta dish, the vegetables are often sautéed prior to the addition of the protein and the sauce. Some vegetables such as garlic and onion are even sautéed ahead of other vegetables such as peppers, broccoli and the like. This happens at time intervals to allow the food to properly cook. The ingredients for each step (recipe) and order and timing of these step intervals (process) are stored in database 12.

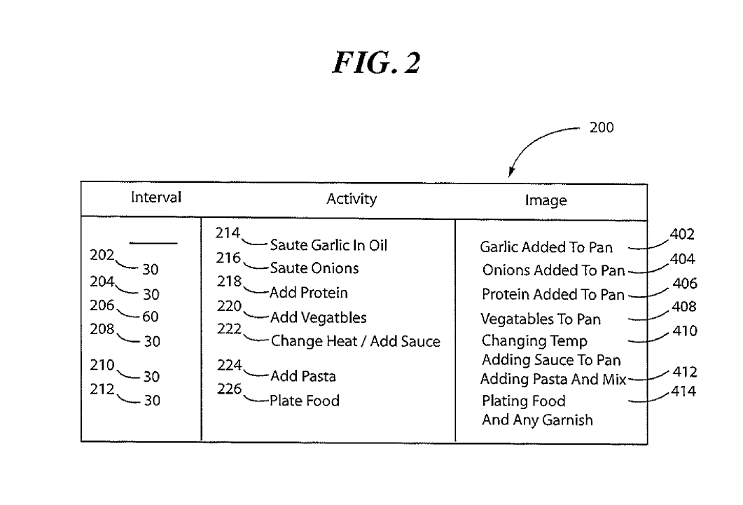

Reference is now made to FIG. 2, wherein a representative memory file for cooking pasta, by way of example, is provided. A time interval, activity, and an image of that activity are mapped to each other in a respective file of memory 200 stored in database 12. By way of non limiting example, a process and recipe for making a pasta dish is provided. Database 12 includes similar memory files for a variety of foods representing at least the menu associated with a kitchen appliance 30.

Following the pasta example, the first activity would be to place the oil with garlic into a heated pan. Because this is the first activity there is no time associated with it. An image 412, either a still photo or a short video clip showing the garlic and oil being placed into the heated pan and sautéed, is stored in memory 200 as an image 402. A 30-second interval 202 is stored. In response to inputs from clock 14, server 10 acts on the stored activity data 214 and at the end of time interval 202, the second step would be shown, and a second stage activity occurs; by way of non limiting example, the sautéing of onions 216. The associated image 404 would be the placing and mixing of the onions within the pan. A further 30-second interval 204 is stored in file 200 and triggers the next activity 218; the protein being added. A still or video image 406 showing meat, fish or poultry being poured into the pan would be stored and associated with this activity 218. A 60-second interval 206 is stored to trigger the next activity 220; adding vegetables simultaneously with retherming the pasta. A stored picture or a video 408 associated and mapped to this activity 220 would show how to perform the step. The next step would be at the end of a 30-second interval 208. In this case, thirty second interval 208 is associated with the trigger for a stored activity 222; sauce being added. A corresponding image 408 showing how to change the heat from medium to high stored as part of the recipe in activity 222 and adding sauce is stored in memory 200. Another 30-second interval 210 is stored and mapped to trigger the next step 224; adding pasta. An image 410 of adding pasta and perhaps stirring, if needed, is stored and mapped to this recipe step in memory 200. At the end of a last 30-second interval 212, plating of the meal occurs so that the timing of the elapsing of 30-second time interval 212, the nature of the activity 226 which is plating, and an image 414 of emptying the pan onto a plate are all stored in memory 200 and mapped for each other.

Memory 200 with the associated activity data 202-414 corresponding to steps in a recipe are shown as a pasta example. However, the files conform to substantially any type of food preparation such as a hamburger where the activities may be the placing of the burger, flipping a burger, moving a burger from one portion of the grill to another depending upon the degree to which the burger is to be cooked, adding cheese, toasting buns, adding onions, bacon or the like. Also, although not shown in the file, the end of each time period could trigger an audio alarm at audio visual display 20 to get the attention of operator 40 to look at audio visual display 20. Lastly, the image may be a still photo, a video, real life action or animation, i.e. any image which demonstrates to user 40 the performance of the desired activity.

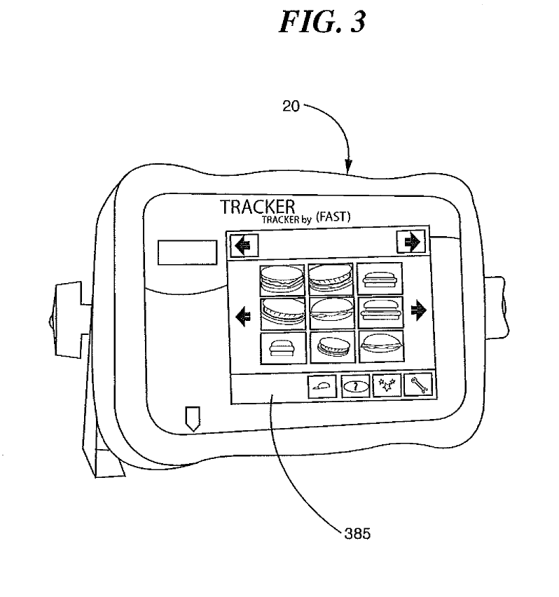

Reference is now made to FIG. 3 in which an audio visual display 20 is provided illustrating an initial step. Audio visual display 20 in an initial step displays all of the potential products on the menu for the kitchen facility. The screen of audio visual display 20 is preferably a touch screen. By selecting the image of interest, either a demand product build information or a product in process information prompt will be provided.

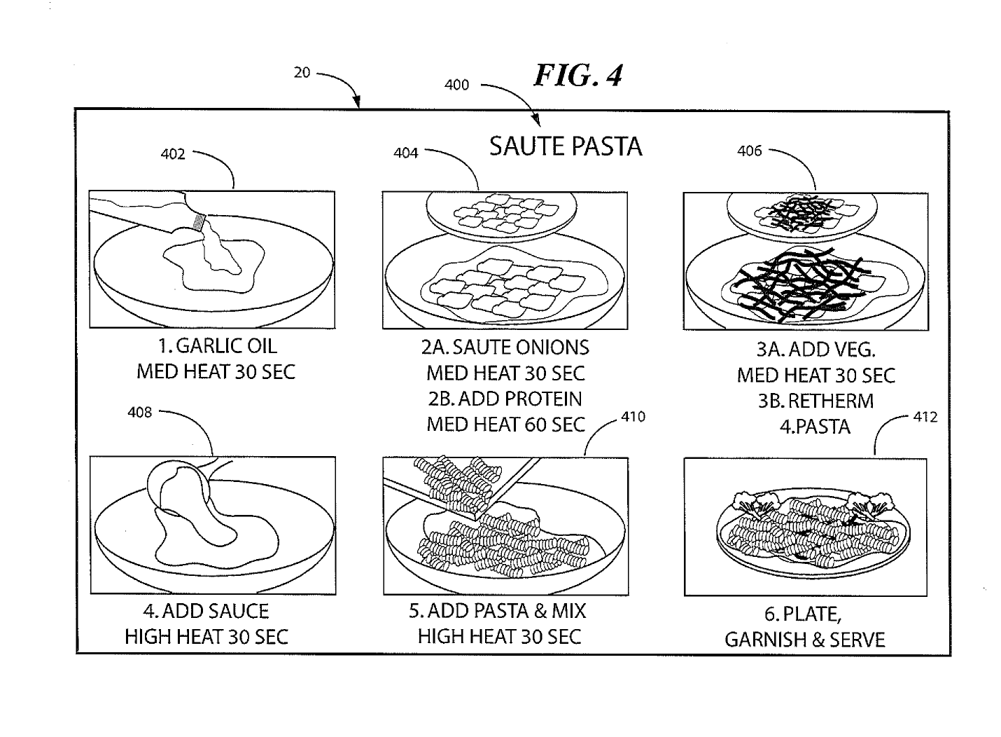

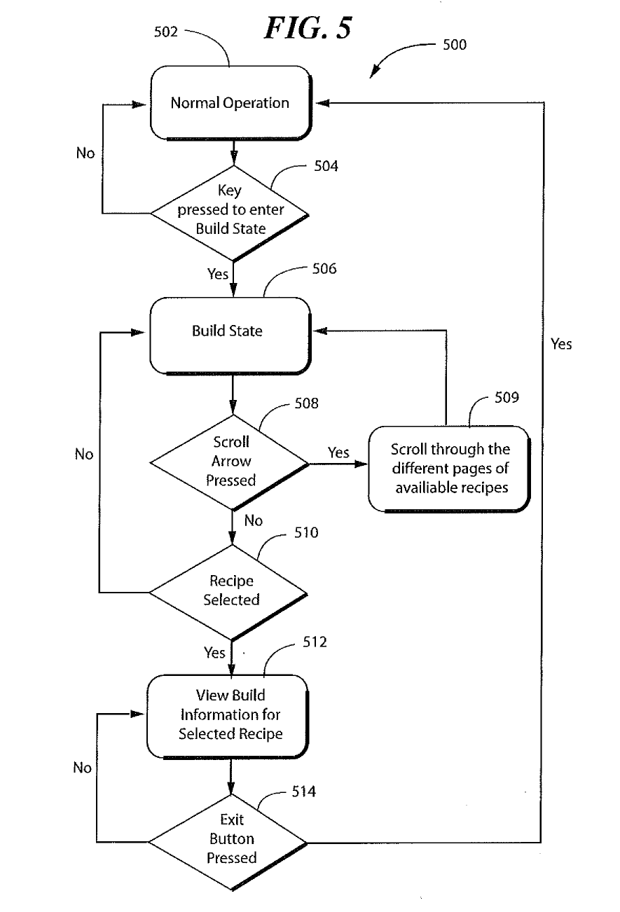

Turning to FIGS. 4 and 5 a demand product build information process is demonstrated. A demand product build information is used as a learning tool or a refresher when on the cooking line to teach the process as a whole for cooking a food product. This process provides the activities of the overall cooking process to operator 40. The demand product build process is an interrupt to normal processing of the operation. Normal operation of system 100 occurs at step 502. In order to begin the demand product build information, a key is pressed at audio visual display 20 to enter the product build process (“Build State”) in a step 504. Once in the build state in step 506, the audio visual representations of the various completed products are provided at audio visual display 20. If the appropriate food item is not displayed at audio visual display 20, then the scroll arrow 385 is pressed in a step 508 and the different recipes are scrolled through in a step 509 until the appropriate item is presented at display 20 to begin the build state in step 506.

Once the appropriate food item is presented, the scroll arrow is no longer depressed and a recipe is selected in a step 510. If a recipe is not selected then the process is returned to the initial build state 506. However, if a recipe is selected by input, rather preferably touching of the touch screen at the presented image, then the build information for the selected recipe is provided in a step 512. The build information is an audio visual cue to teach operator 40 the proper process for cooking the selected recipe.

In one example, a screen as shown in FIG. 4, audio display 20 may show the pasta process in step order 214-226 with each of the associated images 402-414 from the tables of memory 200, so that an overall image 400 shows a first image 402 corresponding to the sautéing of the garlic and oil in the first step. Image 404 showing the sautéing of the onions and adding protein is also shown. A FIG. 408 illustrating the vegetable and retherming of the pasta is shown. Similarly, the images 408-412 corresponding to the successive steps discussed above are shown together. In this way, the entire build state is shown as a tutorial teaching tool or pre-process refresher to operator 40 at kitchen appliance 30. The view may be maintained during the operation as a continued reminder, much like a cook book in a universal language, while cooking.

A second process enabled by the system 100 is the real time prompting of instructions of the cooking process. In the prompt, a respective one of each of images 402-412 would be shown in chronological order at the end of the associated time interval 202-212 which triggers the mapped activity and image. By way of example, at the start, server 10 would obtain the entire recipe from database 12. Server 10 identifies first activity 214 (sautéing garlic) and then transmits image 402 associated with sautéing garlic in oil in accordance with activity 214 to audio visual display 20. Clock 14 would time out a 30 second interval to trigger server 10 to select the second activity 216 which is sautéing onions causing server 10 to display image 404 of onions being added to a pan at audio visual display 20. Similarly, clock 14 would then clock out a second 30 second interval 204 which triggers server 10 to select the next activity to 18 of adding protein. Server 10 selects stored image 406 of protein being added to the pan from database 12 and causes it to be displayed at display 20. At the end of a 60 second interval of heating the protein, the activity 220 of adding vegetables is triggered and an image 408 of adding vegetables would be shown at audio visual display 20. Similarly, at the end of successive time intervals 208, 210 and 212, server 10 in response to a clock input causes images 410, 412 and 414 to each be individually shown at audio visual display 20 in proper order to complete the process by changing the temperature, adding the sauce, and adding pasta to the dish. In this way, the stored images may be utilized in both the build stage and an ongoing cook prompt stage.

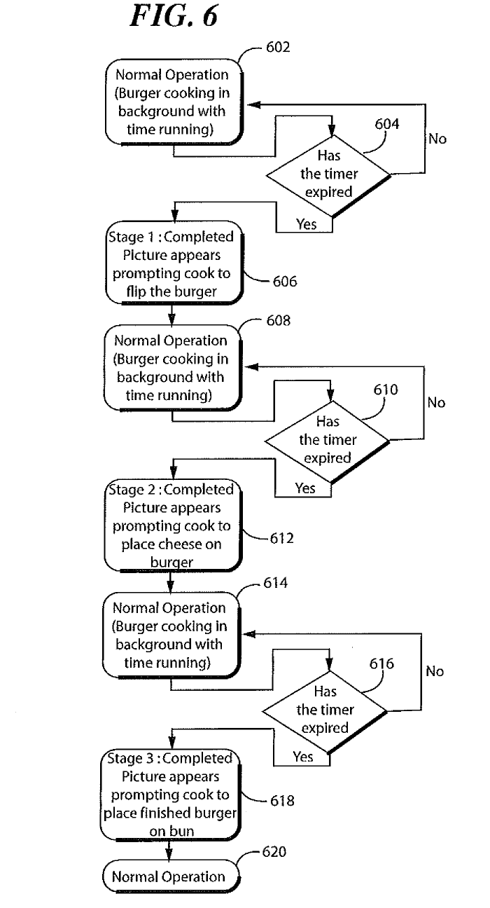

Reference is now made to FIG. 6 in which a method for operating the system in accordance with a product information prompting mode is provided for a second type of food. This embodiment is illustrative of another food preparation process, namely that for a hamburger. As is known, the burger is placed on a grill and normal operation is provided in a step 602. The process has been initialized by communicating with server 10 by and through audio visual display 20 so that the server 10 and clock 14 begin the interval count in the background. In a step 604 it is determined whether the timer for timing the current cooking activity has expired. If not, normal operation continues and nothing is done to the food. If the first stage timer has expired in a step 604, i.e., clock 14 has timed out, this indicates that stage 1 (the first activity) of the process has been completed. Server 10 retrieves the appropriate image from a hamburger memory 200 of database 12 and causes a visual cue to be displayed at display 20 prompting and showing the user to flip the burger in accordance with the next activity in the process in a step 606. In accordance with a preferred embodiment of the invention, an audio tone or visual indicator such as a flashing light may be displayed so that a distracted operator 40 will be cued to look at audio visual display 20 at the end of the elapsed time of a completed stage.

In a step 608 the system returns to normal operation. The burger is cooking on kitchen appliance (a grill) 30. Clock 14 is operating in the background providing a clock input to server 10. It should be noted that a running timer may be displayed at audio visual display 20 to help the operator 40. However, to accommodate multiple recipes being prepared at a single kitchen appliance 30 and utilizing a single audio visual monitor 20, the visual cues corresponding to other foods being cooked may replace the image corresponding to the hamburger in question when no activity is required for the hamburger. In this way, a french fry instruction may be displayed, or an instruction for a second or third burger at a different place in its respective process may be displayed. To facilitate this, the visual cue for stage 1 may be removed at a predetermined time interval, or in response to an active prompt from user 40 such as a touch screen key at audio visual display 20 corresponding to the stage process having been completed.

In a step 610 it is determined whether the timer corresponding to stage 2 of the process has elapsed. If not, then the process returns to normal operation at step 608. If the time has expired, then in step 612, server 10 sends the visual cue corresponding to the next process step to audio visual display 20. In one non limiting example, in step 612, the cue corresponds to prompting the cook to place cheese on the burger in accordance with a cheeseburger recipe; i.e., an image of cheese being placed on a burger. In a step 614 the process returns to normal operation as discussed above.

In a step 616 it is determined whether the timer has expired corresponding to the third stage of the process. If not, the process is maintained in normal operation in accordance with step 614. If server 10 determines that stage 3 has been completed, then server 10 causes the stage 4 visual cue stored in database 12 to be displayed at display 20, prompting the cook to place the finished burger on a bun in a step 618. The entire system then returns to normal operation in a step 620 by either going dormant or showing further ongoing activities corresponding to other food.

When preparing several foods utilizing a single cooking surface, there is often fear of cross contamination. In addition to the recipe for cooking an individual food such as a hamburger or pasta, where food shares a common area such as on a grill, there will be rules as part of the recipe regarding the use of the cooking surface as a function of the foods being prepared. Certain foods are generally not prepared adjacent other foods at various stages of cooking. By way of example, a new chicken breast or hamburger patty is not placed in proximity to an almost completely cooked chicken breast or hamburger patty for fear of cross contamination of bacteria found in raw food, but not in cooked food. Accordingly, server 10 makes use of spacing rules stored in database 12 as a function of the type of food currently being cooked and to be cooked. This process is performed by server 10 ahead of any processing of cooking steps associated with a recipe.

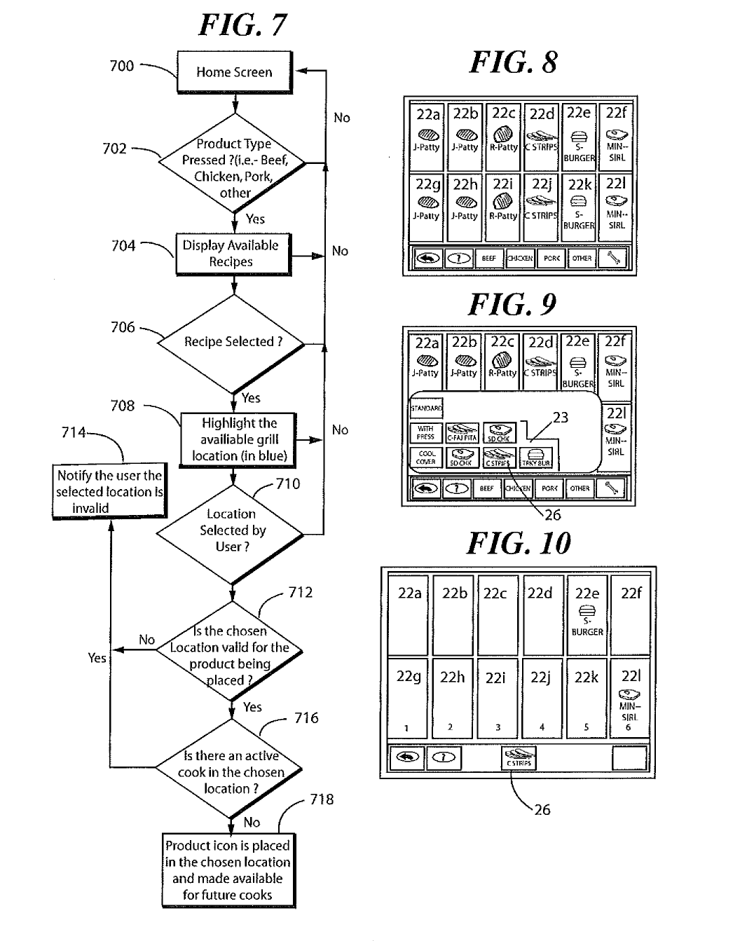

Reference is now made to FIGS. 7-10 wherein the operation of server 10 and the screen shots displayed at audio visual display 20 are provided. As seen in FIG. 8 audio visual display 20 displays a grill divided into segments. In a non limiting, nonpreferred exemplary embodiment, the depicted grill is divided into twelve segments, 22a-22l broken up into two rows and six columns. Each segment 22 corresponds to a position on an actual grill at which food is to be placed.

In accordance with the invention, a home screen is displayed at audio visual display 20 to the user in a step 700. Home screen 22 (FIG. 8) shows projected placing of food for cooking in accordance with anticipated demand and the recipes and rules stored in database 12 to be operated upon by server 10. In the exemplary embodiment, the cooking appliance is a grill which is configured in twelve available positions 22a-22l. Each segment is the position on the grill for receiving food to be cooked. By way of example, positions 22a, 22b, 22g are reserved for jumbo patties. In accordance with the rules, positions 22c and 22l are reserved for regular patties while positions 22e and 22k are reserved for sirloin burgers which are separated by positions 22d, 22j for chicken strips. Mini sirloins are reserved for end quadrants 22f, 22l. In accordance with the rules for cooking an anticipated menu, this is the optimum spacing. In a step 702, a product type such as beef, chicken or one of the patties or foods previously described is selected as an input at audio visual display 20. If no food is selected, the process returns to home screen 700.

If a product is selected, then in a step 704 audio visual display 20 will display available recipes as shown in FIG. 9 in an available recipe display 23. In this non limiting embodiment, available recipe display 23 is a pop-up over the home screen 22 of FIG. 8. The recipes provided in step 704 are a function of recipes stored in database 12 and the ability to cook that recipe in any available position 22a-22l. Server 10 will lock out recipes which are impermissible to be cooked in the available positions and those recipes will not be shown as an available recipe 23.

By way of example, if the rules were in accordance with the display of FIG. 8, mini sirloins are only able to be cooked adjacent a sirloin burger. If position 22a were the only position available for cooking, the recipe for mini sirloin would not be displayed in step 704 because it is impermissible to cook mini sirloin adjacent a jumbo patty under the exemplary rules stored in database 12. Assuming that each position 22b-22e were occupied in accordance with what is shown at home screen 22, only recipes capable of being cooked adjacent a jumbo patty would be displayed which would be the regular patty or the jumbo patty.

In the embodiment shown in FIG. 9, it is assumed that a chicken position was available for purposes of illustration only, and in response to the selection of chicken in step 702, chicken recipes are displayed in step 704 including chicken sandwiches, chicken strips, a chicken fajita pita and a turkey burger, which is treated the same as chicken in accordance with the logic of server 10. Once a recipe is selected in the step 706, by touching, in this embodiment, one of the displayed food item icons, the available grill positions are shown at audio visual display 20 in a step 708. The available positions may be highlighted by color, such as blue. In this example, all but grill location 22e and 22l, are available for the selected recipe. In the inverse, it is well within the scope of the invention to indicate available grill locations by indicating which grill locations are not available either by placing a picture of the product being cooked in each location as in FIG. 10, or by displaying a large X in the occupied positions or the like. In this embodiment, a picture of chicken strips is displayed as a selected recipe icon 26.

In the step 710, a location is selected by the user. If no location is selected, the entire process may return to step 700 and the home screen 22. If a location is selected by the user, server 10 determines whether the chosen location is valid as a function of the placement rules for the product being placed in a step 712, i.e. no chicken near mini sirloin. If not, the user is notified that the selected location is invalid in a step 714 and the available grill spaces are again indicated in step 708.

Even if the selected position is valid, there may be active cooking already occurring in the space. Server 10 stores food items being cooked, mapped to the input position in database 12. In a step 716, server 10 determines whether an active cook is occurring in the selected position. If yes, then the process returns to step 714 and server 10 causes a signal to be output to audio visual display 20 to notify the user that the selected position is invalid. If it is determined in step 716 that there is no active cook in the chosen position, then the product icon 26 corresponding to chicken strips is placed in the chosen position by input at audio visual display 20. Server 10 then changes a status for that position as being unavailable for future cooks during the cook process.

In one embodiment, server 10 utilizes clock 14 to project a countdown timer associated with each food at each position at audio visual display 20. In this way, a user may quickly determine the future availability of positions, and/or the timing to a next step to be performed in the recipe. In a more preferred embodiment, the audio visual cues of the recipe associated with the selected food are displayed in the corresponding position of audio visual display 20 as discussed above. By providing an input at audio visual display 20, the build steps or process of the selected food may be shown across the entire screen of audio visual display 20 as discussed above rather than each respective position 22a-22l of the corresponding food. In this way, if the operator 40 requires to see the steps in more detail, it can be accomplished.

As each food being cooked is input at audio visual display 20, the food being cooked is stored in database 12 along with the position at which it is being cooked. In this way, server 10 acting on the information stored in database 20 can utilize the rules stored in database 12 to determine future availability of cooking positions.

By providing recipes stored in a database with each processed step linked to a visual cue, and a server in communication with an audio visual display within viewing distance of a kitchen appliance being used for that recipe, a system which provides prompting an instruction in real time to the kitchen appliance operator is provided. In this way, forgetfulness and confusion is removed as one cause of improper food preparation. Furthermore, by providing step by step visual cues either in chronological order or as an entire build outline, it is possible to teach chefs or prompt them as a learning tool or as a refresher prior to preparation of an item. Still further, by utilizing sounds and pictures, but not the spoken language, a person's inability to understand spoken instructions from a supervisor is removed.

It should be noted, that server 10 and audio visual display 20 may be located at the same facility or remote from each other across a distributed network. Display 20 and server 10 may be hard wired to each other, communicate wirelessly utilizing cellular technology, radio frequency technology, and the Internet. Server 10 may include a processor for determining intervals from clock inputs, selecting appropriate data from memory files in database 12 and/or inputting the image or audio data to display 20.

While the preferred embodiments of the invention have been illustrated and described, it will be clear the invention is not so limited. Numerous modifications, changes, variations, substitutions and equivalents will occur to those skilled in the art without departing from the spirit and scope of the present invention as described in the claims.

What is claimed as new and desired to be protected by Letters Patent of the United States is:

1. A system for facilitating the preparation of food comprising:
a database, the database storing recipe information regarding a recipe for preparing at least one food item in accordance with the recipe, the recipe including one or more steps, the database storing a visual cue corresponding to the performance of each of the one or more steps;
a server communicating with the database; and
an audio visual display within viewing distance of a kitchen appliance to be used for performance of the recipe, the server causing at least one of the visual cues stored in the database to be displayed at the audio visual display in response to a request from the visual display.

2. The system of claim 1, wherein the database stores one or more time intervals associated with at least one of the one or more steps of the recipe; and
further comprising a clock, the clock providing a clock output to the server, the server determining a next step of the recipe as a function of the output transmitting a visual cue corresponding to the next step.

3. The system of claim 1, wherein said server causing all of the audio visual clues associated with a recipe to be displayed simultaneously at the visual display.

4. The system of claim 2, wherein the clock output corresponds to a running time, the server determining the elapsing of the time interval, and determining the next step of the recipe as a function of determination of the time interval.

5. The system of claim 1, further comprising a kitchen appliance, the audio visual display being disposed within said kitchen appliance.

6. The system of claim 1, wherein said audio visual display includes an audio alarm.

7. The system of claim 2, wherein the server causes an audio alarm upon determination of the end of a time interval.

8. The system of claim 1, wherein said kitchen appliance is an oven.

9. The system of claim 1, wherein said kitchen appliance is a grill.

10. The system of claim 1, wherein the recipe includes rules regarding placement of the food item on the kitchen appliance.

11. The system of claim 1, wherein the server tracks a position of a food being cooked in accordance with the recipe on the food cooking apparatus, and sends a signal to the audio visual display regarding the availability of a position on the cooking apparatus in response to a food type to be cooked input at the audio visual display.

12. A system for facilitating the preparation of food comprising:
a database, the database storing a configuration of cooking positions for a cooking surface of a kitchen appliance, and recipe information regarding a recipe for preparing at least one food item in accordance with the recipe, the recipe information including rules regarding placement of the food item at a respective position;
a server communicating with the database; and
an input/output device within viewing distance of a kitchen appliance, and communicating with the server, the server causing the availability of positions on the kitchen appliance available for cooking the at least one food item to be displayed at the input/output device in response to a request at the input/output device to prepare said at least one food item.

13. The system of claim 12, wherein the input/output device is an audio visual display.

14. The system of claim 13, wherein said server provides an output to the audio visual display causing the audio visual display to display a cooking area of the kitchen appliance.

15. The system of claim 12, wherein the server causes the availability of positions to be displayed as a function of a position on the cooking surface being occupied by the preparing of a second food item.

16. The system of claim 12, wherein the server causes the availability of positions on the kitchen appliance available for cooking to be displayed as a function of a type of second food item being prepared in a position adjacent to a potentially available position of the kitchen appliance.

17. The system of claim 12, wherein the database stores two or more recipes corresponding to two or more respective food items, the server causing an input icon to be displayed at the input/output device of each of the two or more recipes capable of being cooked at the kitchen appliance as a function of the rules.

18. The system of claim 17, wherein said server stores a type of food item and a position of the cooking surface of the kitchen appliance upon which the food item is currently being cooked, and preventing recipes which are not allowed to be cooked in available positions as a function of the rules from being displayed.

19. The system of claim 12, wherein the kitchen appliance is a grill.

20. The system of claim 12, wherein the kitchen appliance is an oven.
